(19) United States
(12) Patent Application Publication
(10) Pub. No.: US 2025/0219933 A1
(43) Pub. Date: Jul. 3, 2025

(54) INTRA-DOMAIN SOURCE ADDRESS VALIDATION FAST REROUTE USING IGPS

(71) Applicant: HUAWEI TECHNOLOGIES CO., LTD., Shenzhen (CN)

(72) Inventors: Yingzhen Qu, Santa Clara, CA (US); Alvaro Enrique Retana, Santa Clara, CA (US)

(21) Appl. No.: 19/013,894

(22) Filed: Jan. 8, 2025

Related U.S. Application Data
(63) Continuation of application No. PCT/US2023/027166, filed on Jul. 7, 2023.
(60) Provisional application No. 63/359,745, filed on Jul. 8, 2022.

(51) Int. Cl. H04L 45/28; H04L 41/0677; H04L 45/00

(52) U.S. Cl. CPC H04L 45/28; H04L 41/0677; H04L 45/22

(57) ABSTRACT

A method implemented by a network node in an interior gateway protocol (IGP) domain. The method includes transmitting a first message to a second network node in the IGP domain. The first message identifies a backup path to be used by the network node upon detection of a failure in the IGP domain. The method further includes detecting the failure after transmission of the first message to the second network node, and transmitting a second message to the second network node following detection of the failure. The second message notifies the second network node to use a backup port in a source address validation (SAV) table to validate packets received on the backup path.

### CROSS-REFERENCE TO RELATED APPLICATIONS

This is a continuation of International Patent Application No. PCT/US2023/027166 filed Jul. 7, 2023, which claims the benefit of U.S. Provisional Patent Application No. 63/359,745, filed Jul. 8, 2022, which are hereby incorporated by reference.

### TECHNICAL FIELD

The present disclosure is generally related to communications using the Internet Protocol (IP) and, more specifically, to source address validation in IP networks with fast reroute.

### BACKGROUND

The IP is the network layer communications protocol in the Internet protocol suite for relaying datagrams across network boundaries. Its routing function enables internetworking, and essentially establishes the Internet.

IP has the task of delivering packets from the source host to the destination host solely based on the IP addresses in the packet headers. For this purpose, IP defines packet structures that encapsulate the data to be delivered. IP also defines addressing methods that are used to label the datagram with source and destination information.

Source address validation (SAV) is a standard formalized in Internet Engineering Task Force (IETF) Request for Comments (RFC) 2827 entitled “Network Ingress Filtering: Defeating Denial of Service Attacks which employ IP Source Address Spoofing” by P. Ferguson, et al., published May 2000. The standard is aimed at discarding packets with spoofed source IP addresses. The absence of SAV is known as a root cause of reflection distributed denial-of-service (DDoS) attacks.

### SUMMARY

The disclosed aspects/embodiments provide techniques for signaling a backup path to be used by a network node upon detection of a failure in an interior gateway protocol (IGP) domain, and for notifying a second network node to use a backup port in a source address validation (SAV) table to validate packets received on the backup path. The techniques use existing IGP (e.g., Open Shortest Path First (OSPF) or Intermediate System-Intermediate System (IS-IS)), in some cases with a simple extension or an additional shortest path first (SPF) calculation, to achieve source address validation (SAV). By implementing SAV using the disclosed techniques, source address validation can be achieved during a fast reroute switchover.

A first aspect relates to a method implemented by a network node in an interior gateway protocol (IGP) domain, comprising: transmitting a first message to a second network node in the IGP domain, wherein the first message identifies a backup path to be used by the network node upon detection of a failure in the IGP domain; detecting the failure after transmission of the first message to the second network node; and transmitting a second message to the second network node following detection of the failure, wherein the second message notifies the second network node to use a backup port in a source address validation (SAV) table on the second network node to validate packets received on the backup path.

Optionally, in any of the preceding aspects, another implementation of the aspect provides that the SAV table is built based on only IGP and not any additional protocol.

Optionally, in any of the preceding aspects, another implementation of the aspect provides that the first message includes a source prefix field and a next hop field, wherein the source prefix field includes a value that identifies the network node, and the next hop field includes a value that identifies a next hop of the network node on the backup path.

Optionally, in any of the preceding aspects, another implementation of the aspect provides that the first message includes a type field, and a value in the type field indicates that the first message includes the backup path.

Optionally, in any of the preceding aspects, another implementation of the aspect provides that the source prefix field, the next hop field, and the type field are included in a sub-type length value (TLV).

Optionally, in any of the preceding aspects, another implementation of the aspect provides that the sub-TLV is included in an Open Shortest Path First version 2 (OSPFv2) TLV or an Open Shortest Path First version 3 (OSPFv3) TLV.

Optionally, in any of the preceding aspects, another implementation of the aspect provides that the OSPFv2 TLV or the OSPFv3 TLV include an address prefix field, and the address prefix field includes a value identifying the second network node or a destination node.

Optionally, in any of the preceding aspects, another implementation of the aspect provides that the second message includes a flags field, and the flags field includes a value that instructs the second network node to switch to the backup port.

Optionally, in any of the preceding aspects, another implementation of the aspect provides that the second message includes a source prefix field and a next hop field, wherein the source prefix field includes a value that identifies the network node, and the next hop field includes a value that identifies a next hop of the network node on the backup path.

Optionally, in any of the preceding aspects, another implementation of the aspect provides that one or both of the first message and the second message comprises an IGP update message, and the IGP update message comprises a link state update (LSU) corresponding to the OSPF protocol or a protocol data unit (PDU), known as a link state PDU (LSP), corresponding to the IS-IS protocol.

Optionally, in any of the preceding aspects, another implementation of the aspect provides transmitting packets on the backup path after the failure has been detected.

A second aspect relates to a method implemented by a network node in an interior gateway protocol (IGP) domain, comprising: receiving a first message from a second network node in the IGP domain, wherein the first message identifies a backup path to be used by the second network node upon detection of a failure in the IGP domain; updating a source address validation (SAV) table to include a backup port corresponding to the backup path; and receiving a second message from the second network node, wherein the second message notifies the network node to use the backup port in the SAV table on the second network node to validate packets received on the backup path.

Optionally, in any of the preceding aspects, another implementation of the aspect provides performing a shortest path first (SPF) calculation using a value of zero for a metric between the second network node and a next hop of the second network node to update the SAV table.

Optionally, in any of the preceding aspects, another implementation of the aspect provides performing an initial SPF calculation to generate the SAV table, wherein the initial SPF calculation is performed prior to the SPF calculation.

Optionally, in any of the preceding aspects, another implementation of the aspect provides that the SAV table includes a backup port column identifying the backup port.

Optionally, in any of the preceding aspects, another implementation of the aspect provides that the first message includes a source prefix field and a next hop field, wherein the source prefix field includes a value that identifies the second network node, and the next hop field includes a value that identifies a next hop of the second network node on the backup path.

Optionally, in any of the preceding aspects, another implementation of the aspect provides that the first message includes a type field, and a value in the type field indicates that the first message includes the backup path.

Optionally, in any of the preceding aspects, another implementation of the aspect provides that the source prefix field, the next hop field, and the type field are included in a sub-type length value (TLV).

Optionally, in any of the preceding aspects, another implementation of the aspect provides that the sub-TLV is included in an Open Shortest Path First version 2 (OSPFv2) TLV, an Open Shortest Path First version 3 (OSPFv3) TLV, an Extended Internet Protocol version 4 (IPv4) Reachability TLV, a Multi-Topology IPv4 Reachability TLV, an Internet Protocol version 6 (IPv6) Reachability TLV, or a Multi-Topology IPv6 Reachability TLV.

Optionally, in any of the preceding aspects, another implementation of the aspect provides that the OSPFv2 TLV or the OSPFv3 TLV include an address prefix field, and wherein the address prefix field includes a value identifying the network node or a destination node.

Optionally, in any of the preceding aspects, another implementation of the aspect provides that the second message includes a flags field, wherein the flags field includes a value that instructs the network node to switch to the backup port.

Optionally, in any of the preceding aspects, another implementation of the aspect provides that the second message includes a source prefix field and a next hop field, wherein the source prefix field includes a value that identifies the second network node, and wherein the next hop field includes a value that identifies a next hop of the second network node on the backup path.

Optionally, in any of the preceding aspects, another implementation of the aspect provides receiving a packet; verifying that the packet was received on the backup port corresponding to the second network node using the SAV table; and transmitting the packet from an outgoing port corresponding to a destination address using a forwarding information base (FIB) table.

Optionally, in any of the preceding aspects, another implementation of the aspect provides receiving a packet; determining that the packet was not received on the backup port corresponding to the second network node using the SAV table; and dropping the packet or transmitting the packet somewhere for further inspection.

A third aspect relates to a network node in an interior gateway protocol (IGP) domain, comprising: a memory configured to store instructions; and one or more processors coupled to the memory and configured to execute the instructions to cause the network node to perform the method of any of the disclosed embodiments.

A fourth aspect relates to a non-transitory computer readable medium comprising a computer program product for use by a network node, the computer program product comprising computer executable instructions stored on the non-transitory computer readable medium that, when executed by one or more processors, cause the network node to execute the method of any of the disclosed embodiments.

A fifth aspect relates to a network node in an interior gateway protocol (IGP) domain, comprising means for performing the method of any of the disclosed embodiments.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a network topology including an Interior Gateway Protocol (IGP) domain.

FIG. 2 is a schematic diagram of a network topology including the IGP domain.

FIG. 3 is an illustration of a distributed source address validation (DSAV) workflow.

FIG. 4 is a schematic diagram of a loop-free alternate (LFA) fast reroute (FRR) procedure.

FIG. 5 is a schematic diagram of a remote LFA FRR procedure.

FIG. 6 is an illustration of a SAV table built to accommodate the LFA FRR and remote LFA FRR procedures according to an embodiment of the disclosure.

FIG. 7 is an OSPFv2 Extended Prefix TLV according to an embodiment of the disclosure.

FIG. 8 is a sub-TLV for prefix level encoding according to an embodiment of the disclosure.

FIG. 9 is a sub-TLV for prefix level encoding according to an embodiment of the disclosure.

FIG. 10 is a method implemented by a network node in the IGP domain according to an embodiment of the disclosure.

FIG. 11 is a method implemented by a network node in the IGP domain according to an embodiment of the disclosure.

FIG. 12 is a schematic diagram of a network apparatus according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

An IP packet (or simply, a packet) has a source address and a destination address. As noted above, IP source address spoofing is the practice of maliciously sending packets with a forged or incorrect source address.

Mutually Agreed Norms for Routing Security (MANRS) is a global initiative that helps reduce the most common routing threats. MANRS provides a set of best practices based on existing norms for network operators to improve the security of the global Internet routing system. One of the best practices relates to anti-spoofing, and has the goal of enabling source address validation (SAV) and implementing anti-spoofing to prevent packets with incorrect source IP addresses from entering and leaving the network.

SAV is a problem with a long history of attention by the Internet Engineering Task Force (IETF). Numerous IETF documents describe anti-spoofing techniques. Best Current Practice (BCP) 38/Internet Engineering Task Force (IETF) Request for Comments (RFC) 2827 entitled “Network Ingress Filtering: Defeating Denial of Service Attached which employ IP Source Address Spoofing” by P. Ferguson, et al., published May 2000, discloses techniques used to block IP packets that have the source IP address forged at the edge of the Internet from entering the Internet.

IETF RFC 6959 entitled “Source Address Validation Improvement (SAVI) Threat Scope” by D. McPherson, et al., published May 2013, discloses techniques used for source address spoof-based threats and existing solutions.

IETF RFC 2267 entitled “Network Ingress Filtering: Defeating Denial of Service Attached which employ IP Source Address Spoofing” by P. Ferguson, et al., published January 1998, which along with RFC 2827, disclose techniques used for ingress filtering and access control list (ACL)-based SAV. One problem with these techniques is the need for manual configuration of network devices.

IETF RFC 3704 entitled “Ingress Filtering for Multihomed Networks” by F. Baker, et al., published March 2004, discloses strict unicast reverse path forwarding (strict-uRPF) and feasible-uRPF. One problem with these techniques is that they improperly block packets when there is asymmetric routing, and they improperly permit packets to be routed in some circumstances.

IETF RFC 6620 entitled “FCFS SAVI: First-Come, First-Served Source Address Validation Improvement for Locally Assigned IPV6 Addresses” by E. Nordmark, et al., published May 2012, IETF RFC 7030 entitled “Enrollment over Secure Transport” by M. Pritikin, et al., published October 2013, IETF RFC 7039 entitled “Source Address Validation Improvement (SAVI) Framework” by J. Wu, et al., published October 2013, IETF RFC 7219 entitled “SEcure Neighbor Discovery (SEND) Source Address Validation Improvement (SAVI)” by M. Bagnulo, et al., published May 2014, IETF RFC 7513 entitled “Source Address Validation Improvement (SAVI) Framework” by J. Wu, et al., published October 2013, IETF RFC 8074 entitled “Source Address Validation Improvement (SAVI) Solution for DHCP” by J. Bi, et al., published May 2015, and IETF RFC 8074 entitled “Source Address Validation Improvement (SAVI) for Mixed Address Assignment Methods Scenario” by J. Bi, et al., published February 2017, along with RFC 6959, disclose techniques for source address validation improvement. One problem with these techniques is how they deal with host-level SAV in access networks (enterprise networks).

IETF RFC 6620 entitled “FCFS SAVI: First-Come, First-Served Source Address Validation Improvement for Locally Assigned IPV6 Addresses” by E. Nordmark, et al., published May 2012, discloses enhanced feasible path (EFP), which mitigates problems associated with strict-uRPF/feasible-uRPF in some cases.

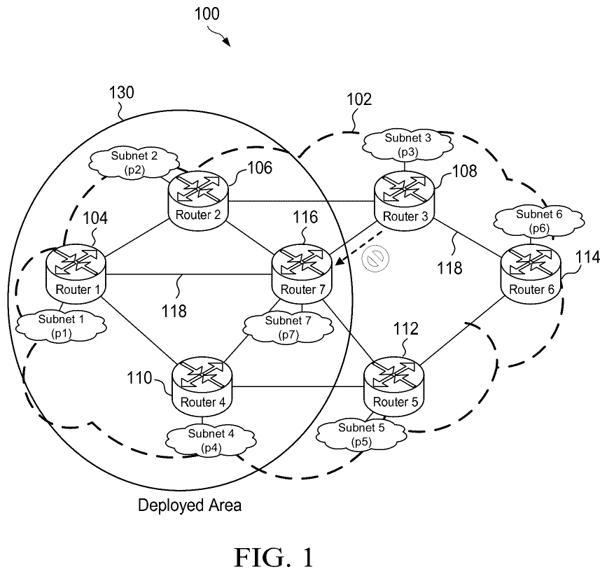

FIG. 1 is a schematic diagram of a network topology 100 including an Interior Gateway Protocol (IGP) domain 102. The IGP domain 102 comprises a plurality of network nodes 104, 106, 108, 110, 112, 114, and 116. While seven network nodes 104-116 are shown in the IDP domain 102, more or fewer network nodes may be included in practical applications. In an embodiment, the network nodes 104-116 comprise a router, a switch, or other network device capable of routing packets through the IGP domain 102.

Some of the network nodes, e.g., network nodes 104, 114, are disposed at an edge of the IGP domain 102. The network nodes 104, 114 receiving packets from outside the IGP domain 102 may be referred to as ingress network nodes. The network nodes 104, 114, transmitting packets out of the IGP domain 102 may be referred to as egress network nodes. Depending on the direction of multicast packet traffic, either of the network nodes 104, 114 may function as an ingress network node or an egress network node. While not shown, the network nodes disposed at an edge of the IGP domain 102 may be coupled to nodes disposed outside the IGP domain 102. The network nodes that are not disposed at an edge of the IGP domain 102, e.g., network nodes 108, 110, 116, may be referred to intermediate network nodes, internal network nodes, or transit nodes.

The network nodes 104-116 are coupled to each other via links 118. The links 118 may be wired, wireless, or some combination thereof. As discussed more fully below, each of the links 118 have a cost based, for example, on the bandwidth of the length. The links 118 also couple each of the network nodes 104-116 to another subnetwork. The subnetworks in FIG. 1 are labeled Subnet 1 (p1), Subnet 2 (p2), Subnet 2 (p2), Subnet 3 (p3), Subnet 4 (p4), Subnet 5 (p5), Subnet 6 (p6), and Subnet 7 (p7).

FIG. 1 illustrates that applying strict-uRPF only at a subnet port in intra-domain SAV results in an improper permit problem. When all of the network devices 104-116 make the same deployment of, for example, a strict-uRPF policy, then there is no problem. However, when only some of the network devices, e.g., the network devices 104, 106, 110, and 116 within the deployed area 130, apply the strict-uRPF policy at their subnet port spoofing may still occur. For example, when network device 108 (a.k.a., Router 3) sends packets to network device 116 by spoofing the source addresses of Subnet 1 associated with network device 104, by spoofing the source addresses of Subnet 2 associated with network device 106, or by spoofing the source addresses of Subnet 4 associated with network device 110 (as shown by the dashed arrow), the network device 116 will improperly permit the packets. Thus, subnets outside the deployed area 130 are able to spoof addresses of subnets within the deployed area 130.

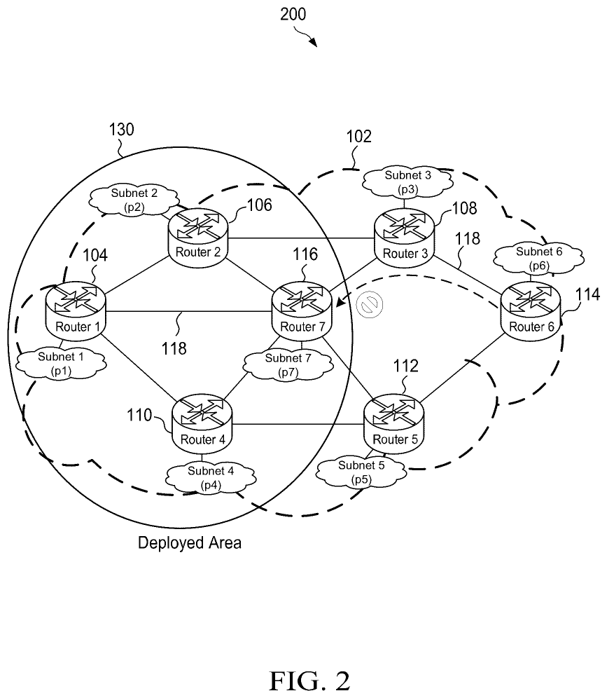

FIG. 2 is a schematic diagram of a network topology 200 including an IGP domain 102. The IGP domain 102 comprises a plurality of network nodes 104, 106, 108, 110, 112, 114, and 116. While seven network nodes 104-116 are shown in the IDP domain 102, more or fewer network nodes may be included in practical applications. In an embodiment, the network nodes 104-116 comprise a router, a switch, or other network device capable of routing packets through the IGP domain 102.

The network nodes 104-116 are coupled to each other via links 118. The links 118 may be wired, wireless, or some combination thereof. As discussed more fully below, each of the links 118 have a cost based, for example, on the bandwidth of the length. The links 118 also couple each of the network nodes 104-116 to another subnetwork. The subnetworks in FIG. 2 are labeled Subnet 1 (p1), Subnet 2 (p2), Subnet 2 (p2), Subnet 3 (p3), Subnet 4 (p4), Subnet 5(p5), Subnet 6 (p6), and Subnet 7 (p7). As shown, some of the network devices e.g., the network devices 104, 106, 110, and 116, are disposed within the deployed area 130.

In FIG. 2, the network device 116 applies strict-uRPF at all subnet ports in intra-domain SAV. However, this results in an improper block problem when there is asymmetric routing. Asymmetric routing occurs when the path between network nodes is not the same in both directions. For example, assume the routing path from the network node 116 to the network node 114 is network node 116→network node 112→network node 114, and the routing path from the network node 114 to the network node 116 is network node 114→network node 108→network node 116. In such cases, when the network device 114 sends valid packets to the network device 116, the network device 116 will improperly block the packets (as shown by the dashed arrow).

When all of the network devices 104-116 make the same deployment of, for example, a strict-uRPF policy, then there is no problem. However, when only some of the network devices, e.g., the network devices 104, 106, 110, and 116 within the deployed area 130, apply the strict-uRPF policy at their subnet port spoofing may still occur. For example, when network device 108 (a.k.a., Router 3) sends packets to network device 116 by spoofing the source addresses of Subnet 1 associated with network device 104, by spoofing the source addresses of Subnet 2 associated with network device 106, or by spoofing the source addresses of Subnet 4 associated with network device 110 (as shown by the dashed arrow), the network device 116 will improperly permit the packets. Thus, subnets outside the deployed area 130 are able to spoof addresses of subnets within the deployed arca 130.

One of the existing solutions that attempts to address the spoofing issue is known as distributed source address validation (DSAV). DASV is discussed in detail in the IETF document entitled “Distributed Source Address Validation (DSAV) Framework” (draft-li-dsav-framework-01) by D. Li, et al., published Jan. 11, 2022. In DASV, a source address is validated using SAV tables generated by a distributed control-plane protocol. That is, the DSAV framework depends on a distributed control-plane protocol to generate an accurate SAV table instead of using uRPF. DSAV provides periodic or triggered updates (when a routing information changes) to distribute SAV rules to network nodes.

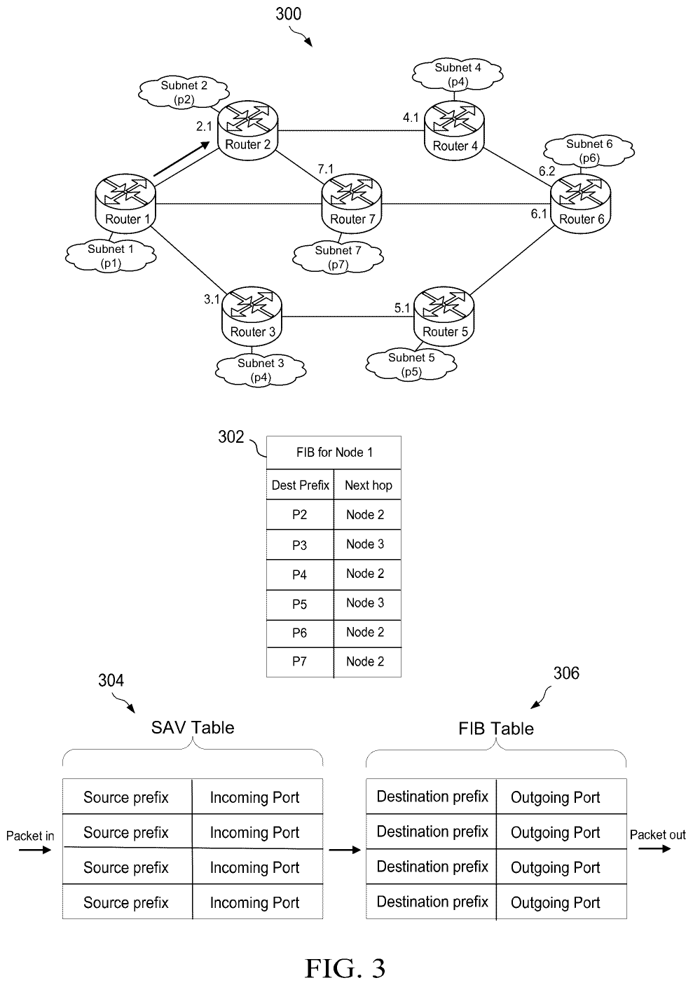

FIG. 3 is an illustration 300 of a distributed source address validation (DSAV) workflow. In the illustrated example, various network nodes, labeled Router 1 through Router 7, are coupled together via links. Each of the network nodes is coupled to a corresponding subnetwork, labeled Subnet 1 through Subnet 7. The network nodes, links, and subnetworks depicted in FIG. 3 are similar to the network nodes, links, and subnets depicted in FIGS. 1-2. For the sake of brevity, a detailed description of these elements is not repeated herein.

The process of prefix notification is described from the perspective of Router 1 and Subnet 1 (p1). As shown, p1 is the source prefix of Router 1. Therefore, Router 1 conducts message origination. Router 1 stores or has access to a forwarding information base (FIB) table 302. The FIB table 302 includes a destination prefix and corresponding next hop for each other subnetwork associated with a network node in the network. The FIB table 302 indicates that for the destination prefixes p2, p4, p6, and p7, the next hop is Router 2 (i.e., Node 2). Therefore, Router 1 generates a notification message and transmits the notification message to Router 2. The notification message includes a source prefix (e.g., p1) and a propagation scope (e.g., p2, p4, p6, p7).

Still referring to FIG. 3, Router 1 uses the DSAV process to build a SAV table 304. The SAV table 304 is then used by Router 1 to validate the source of incoming or received packets. For example, Router 1 checks to see whether a packet received at an incoming port listed in the SAV table 304 has the corresponding prefix listed in the SAV table 304. If not, Router 1 determines the packet may have a spoofed address and drops the packet. If so, Router 1 transmits the packet from the outgoing port in the FIB table 306 (which is a generic representation of FIB table 302) corresponding to the destination prefix in the packet.

While the DSAV framework depicted in FIG. 3 may address some spoofing problems, there are still drawbacks. For example the DSAV framework uses an entirely new protocol to generate the SAV table 304. In addition, the DSAV framework makes achieving full deployment difficult, and adds a significant amount of control plane traffic and states. Moreover, the DSAV framework relies on reactive convergence. That is, when a network failure occurs (e.g., a network node or link fails), forwarding can start working only after SAV converges.

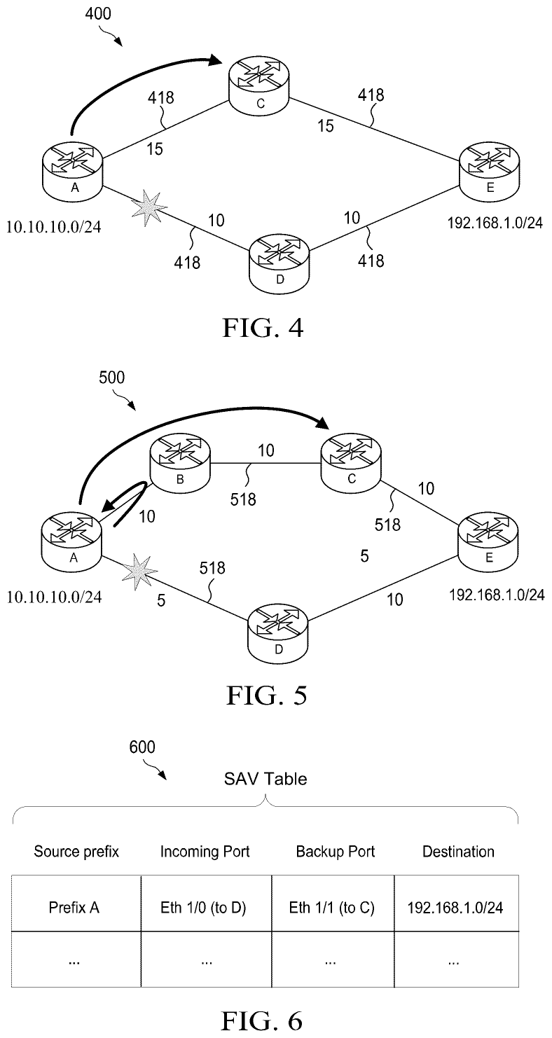

FIG. 4 is a schematic diagram 400 of a loop-free alternate (LFA) fast reroute (FRR) procedure. In the illustrated example, various network nodes, labeled Router A, C, D, and E, arc coupled together via links 418. The network nodes and links depicted in FIG. 4 are similar to the network nodes and links depicted in FIGS. 1-2. For the sake of brevity, a detailed description of these elements is not repeated herein.

In FIG. 4, the network nodes A, C, D, and E are disposed in an Interior Gateway Protocol (IGP) domain. Thus, the network nodes (e.g., routers) utilize open shortest path first (OSPF) or Intermediate System—Intermediate System (IS-IS) to route IP packets (or simply, packets) in the IGP domain of an IP network.

OSPF uses a link state routing (LSR) algorithm and falls into the group of interior gateway protocols (IGPs) operating within a single autonomous system (AS). OSPF gathers link state information from available routers and constructs a topology map of the network. The topology is presented as a routing table to the Internet Layer for routing packets by their destination IP address. OSPF supports Internet Protocol Version 4 (IPv4) and Internet Protocol Version 6 (IPv6) networks. OSPF version 2 (OSPFv2) is defined for IPV4 by RFC 2328 entitled “OSPF Version 2” by J. Moy, et al., published April 1998. OSPF version 3 (OSPFv3) is defined for IPV6 in RFC 5340 entitled “OSPF Version 3” by R. Coltun, et al., published July 2008. OSPF is widely used in large enterprise networks.

Intermediate System to Intermediate System (IS-IS, or ISIS) is a link-state routing protocol. IS-IS operates by flooding link state information throughout a network of routers. Each IS-IS router independently builds a database of the network's topology, thereby aggregating the flooded network information. Like the OSPF protocol, IS-IS computes the best path through the network. Packets (or datagrams) are then forwarded, based on the computed ideal path, through the network to the destination.

Intermediate System to Intermediate System (IS-IS, or ISIS) is another LSR routing protocol designed to move information efficiently within a computer network, a group of physically connected computers, or similar devices. IS-IS accomplishes this by determining the best route for data through a packet switching network. The IS-IS protocol is defined in RFC 1142 entitled “OSI IS-IS Intra-domain Routing Protocol” by D. Oran, published February 1990. IS-IS is common in large service provider networks.

In FIG. 4, each of the links 418 has a metric. For example, the link 418 between Router A and Router C has a metric of 15, and the link 418 between Router C and Router E has a metric of 15. The link 418 between Router A and Router D has a metric of 10, and the link 418 between Router D has a metric of 10.

Router A runs an SPF calculation and determines that the lowest cost path from Router A to Router E is through Router D based on the metrics shown in FIG. 4. Thus, Router A normally transmits packets to Router E over a primary path of Router A→Router D→Router E. However, Router A has detected or been informed of a failure in the IGP domain. The failure may be, for example, a failure of the link 418 between Router A and Router D or the failure of Router D. Because of the failure, Router A is no longer able to transmit packets to Router E over the primary path. Therefore, Router A institutes the LFA FRR procedure.

LFA-FRR permits a router (e.g., Router A) to quickly switch from a primary path to a backup path when the primary path fails, until the network reconverges. As shown in FIG. 4, the backup path comprises Router A→Router C→Router E. The switchover may occur, for example, in about fifty milliseconds (50 ms). Further details regarding LFA-FRR are disclosed in IETF RFC 5286 entitled “Basic Specification for IP Fast Reroute: Loop-Free Alternates” by A. Atlas, et al., published September 2008.

Router A uses IGP to pre-compute the backup path. That is, Router A computes the backup path before detecting the failure. As shown in FIG. 4, the next hop for Router A on the backup path is Router C. The next hop for Router A is installed in the FIB of Router A when the backup path is computed. Therefore, when the backup path is implemented by Router A, packets are transmitted to Router C (as represented by the arrow) instead of Router D.

Unfortunately, Router E may be unaware that Router A has a backup path, has started using that backup path, or both. Therefore, when Router E receives packets from Router A, Router E attempts to validate those packets using the SAV table on Router E. However, the SAV table indicates that packets from Router A are expected to be received on the port (a.k.a., interface) corresponding to Router D, not Router C. As such, Router E is unable to validate the packets and those packets are dropped, even though the packets are valid and have not been spoofed.

FIG. 5 is a schematic diagram 500 of a remote LFA FRR procedure. In the illustrated example, various network nodes, labeled Router A, B, C, D, and E, are coupled together via links 518. The network nodes and links depicted in FIG. 5 are similar to the network nodes and links depicted in FIGS. 1-2. For the sake of brevity, a detailed description of these elements is not repeated herein.

In FIG. 5, the network nodes A, B, C, D, and E are disposed in an IGP domain. Thus, the network nodes (e.g., routers) utilize OSPF or IS-IS to route IP packets (or simply, packets) in the IGP domain of an IP network.

In FIG. 5, each of the links 518 has a metric. For example, the link 518 between Router A and Router B has a metric of 10, the link 518 between Router B and Router C has a metric of 10, and the link 518 between Router C and Router E has a metric of 10. The link 518 between Router A and Router D has a metric of 5, and the link 518 between Router D and Router E has a metric of 10.

Router A runs an SPF calculation and determines that the lowest cost path from Router A to Router E is through Router D based on the metrics shown in FIG. 5. Thus, Router A normally transmits packets to Router E over a primary path of Router A→Router D→Router E. However, Router A has detected or been informed of a failure in the IGP domain. The failure may be, for example, a failure of the link 518 between Router A and Router D or the failure of Router D. Because of the failure, Router A is no longer able to transmit packets to Router E over the primary path. Therefore, Router A institutes the LFA FRR procedure.

Remote LFA-FRR permits a router (e.g., Router A) to quickly switch from a primary path to a backup path when the primary path fails, until the network reconverges. Remote LFA-FRR permits the backup path to be more than one hop away from the router that calculates the backup path (e.g., Router A). As shown in FIG. 5, the backup path comprises Router A→Router B→Router C→Router E. Further details regarding remote LFA-FRR are disclosed in IETF RFC 7490 entitled “Remote Loop-Free Alternate (LFA) Fast Reroute (FRR)” by S. Bryant, et al., published September 2008.

Router A uses IGP to pre-compute the backup path. That is, Router A computes the backup path before detecting the failure. When the failure is detected and Router A switches to the backup path, if Router A tries to send packets toward Router E using Router B as the next hop, Router B transmits the packets back to Router A based on the FIB on Router B. That is, Router B loops traffic back to Router A (as represented by the small arrow). Because of this, Router B is not use5 as the next hop in remote LFA FRR. Instead, Router A tunnels traffic to Router C to bypass the loop.

Thus, the next hop for Router A on the backup path is Router C. The next hop for Router A is installed in the FIB of Router A when the backup path is computed. When the backup path is implemented by Router A, packets are transmitted to Router C (as represented by the arrow) instead of Router D or Router B.

Unfortunately, Router E may be unaware that Router A has a backup path, has started using that backup path, or both. Therefore, when Router E receives packets from Router A, Router E attempts to validate those packets using the SAV table on Router E. However, the SAV table indicates that packets from Router A are expected to be received on the port (a.k.a., interface) corresponding to Router D, not Router C. As such, Router E is unable to validate the packets and those packets are dropped, even though the packets are valid and have not been spoofed.

Disclosed herein are techniques for signaling a backup path to be used by a network node upon detection of a failure in an interior gateway protocol (IGP) domain, and for notifying a second network node to use a backup port in a source address validation (SAV) table to validate packets received on the backup path. The techniques use existing IGP (e.g., Open Shortest Path First (OSPF) or Intermediate System-Intermediate System (IS-IS)), in some cases with a simple extension or an additional shortest path first (SPF) calculation, to achieve source address validation (SAV). By implementing SAV using the disclosed techniques, source address validation can be achieved during a fast reroute switchover.

FIG. 6 is an illustration of a SAV table 600 built to accommodate the LFA FRR and remote LFA FRR procedures according to an embodiment of the disclosure. An example of how to build the SAV table 600 from the perspective of Router E is provided. Notably, the same procedure may be similarly used by other routers in the domain to build their own SAV table.

To begin, Router E receives a link state announcement from one or more of the other network nodes in the IGP domain. That is, Router E receives a link state announcement from Router A, Router B, Router C, and/or Router D. In an embodiment, the link state announcement is a link state update (LSU) corresponding to the OSPF protocol. In an embodiment, the link state announcement is a protocol data unit (PDU), known as a link state PDU (LSP), corresponding to the IS-IS protocol.

Router E performs a shortest path first (SPF) calculation based on the link state announcement received from the other network nodes. Thereafter, Router E builds forwarding information base (FIB) table (not shown) based on the SPF calculation.

In an embodiment, Router E builds the SAV table 600 using the information from the link state announcement and/or the FIB. As shown, the SAV table 600 includes an entry (e.g., Prefix A) corresponding to Router A in a first row of the source prefix column, and includes an entry (e.g., Eth 1/0 (to D)) corresponding to Router D in the incoming port column. These entries ensure that packets received from Router D are determined to be valid.

In an embodiment, the incoming port column in the SAV table 600 is associated with a particular destination (or group of destinations). For example, packet traffic intended for destination 192.168.1.0/24 will be routed from Router A to Router D and thus come in to Router E via Router D. Because the SAV table 600 identifies a separate destination (or destination prefix) for each incoming port, the SAV table 600 may be referred to as a SAV table for prefix level encoding.

In an embodiment, the SAV table 600 includes a backup port column. In an embodiment, the backup port column is initially empty (i.e., does not include an entry) when the SAV table 600 is generated. Any entry in the backup port column identifies the port packets will be received on when the router listed in the Source prefix column is using a backup path. The entry in the backup port column ensures that packets received from Router C are determined to be valid when a backup path is being utilized by the network node listed in the Source prefix column.

While the SAV table 600 in FIG. 6 depicts only a single row, the SAV table 600 may include a plurality of rows in practical applications. Indeed, the SAV table 600 may include one or more rows corresponding to each network node in the IGP domain. For example, the SAV table 600 may include a first row for Prefix A corresponding to Router A, a second row for Prefix B corresponding to Router B, a third row for Prefix C corresponding to Router C, and so on.

After the SAV table 600 has been generated, Router E receives a first update message from Router A. In an embodiment, the first update message identifies the backup path to be used by Router A upon detection of a failure in the IGP domain. As will be more fully explained below, the first update message identifies a destination for a packet, a source of the packet, and a next hop of the source of the packet.

In an embodiment, Router E performs an SPF calculation using a value of zero for the metric between the source (e.g., Router A) and the next hop of the source (e.g., Router B) to update the SAV table 600. Based on this SPF calculation and/or the backup path in the first message, Router E is able to determine that packets received from Router C are valid when Router A is using the backup path. Router E then updates the SAV table 600 to include a backup port (i.e., Eth 1/1 (to C)) corresponding to the backup path.

In an embodiment, Router E updates the SAV table by inserting an entry for the backup port into a row of the backup port column that was initially empty or had not been populated yet. In an embodiment, Router E updates the SAV table 600 by replacing the existing entry in the backup port column with the backup port identified in the first update message. In an embodiment, Router E updates the SAV table 600 by first adding the backup port column to the SAV table 600 and then inserting an entry for the backup port into a row of the backup port column.

Despite the SAV table 600 having been built on Router E, Router E does not know when another router (e.g., Router A) has detected a failure and started using the backup path. That is, until being notified, Router E is unaware that Router A is using the backup path. Therefore, Router E will not use the entry in the backup port column instead of the entry in the incoming port column of the SAV table 600 when Router A is using the backup path, resulting in valid packets being dropped by Router E.

In order to notify Router E that Router A has detected a failure and has switched to the backup path, Router A transmits a second update message to Router E. The second update message notifies Router E to use the backup port in the SAV table to validate packets received on the backup path. That is, the second update message notifies Router E to make the switchover from validating incoming packets using the entry in the incoming port column in the SAV table 600 to validating packets using the entry in the backup port column in the SAV table 600.

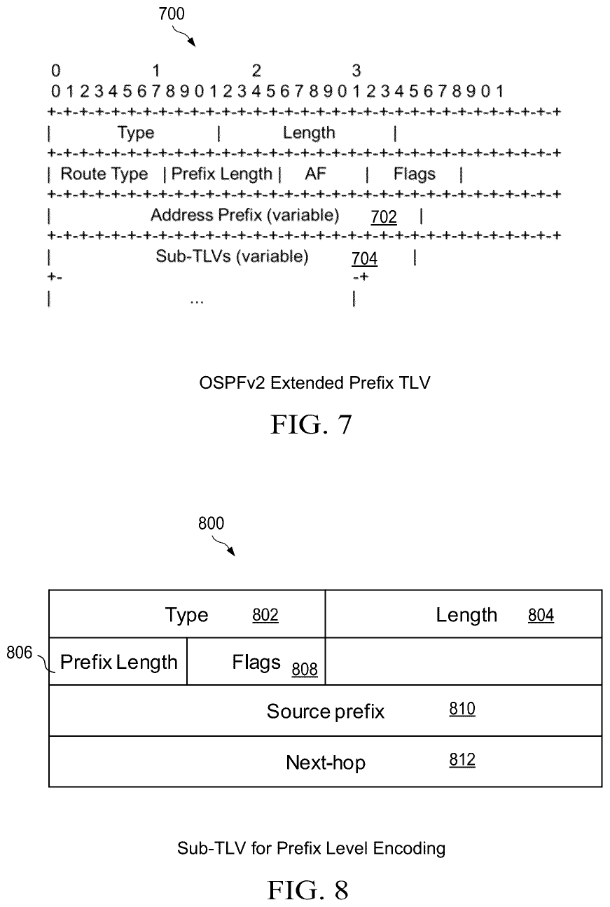

FIG. 7 is an OSPFv2 Extended Prefix TLV 700 according to an embodiment of the disclosure. The OSPFv2 Extended Prefix TLV 1000 is described in detail in IETF RFC 7684 entitled “OSPFv2 Prefix/Link Attribute Advertisement” by P. Psenak, et al., published November 2015.

As shown, the OSPFv2 Extended Prefix TLV 700 includes an Address Prefix field 702 and a sub-TLVs field 704. The Address Prefix field 702 includes a value indicating a destination prefix (or destination) to be used by the receiving router when the receiving router builds a SAV table. For example, the Address Prefix field 702 includes a value to indicate the destination prefix, e.g., the destination prefix 192.168.1.0/24 in FIG. 6. In an embodiment, the Address Prefix field 702 has a variable length. The sub-TLVs field 704 is configured to carry one or more sub-TLVs, as will be more fully explained below.

FIG. 8 is a sub-TLV 800 for prefix level encoding according to an embodiment of the disclosure. The sub-TLV 800 is configured to be included in the sub-TLVs field 704 in FIG. 7. In an embodiment, the sub-TLV 800 is used by a network node (e.g., Router A) to advertise a backup path to be used following the detection of a failure in the IGP domain, and to advertise a switchover to the backup path after detection of the failure.

As shown, the sub-TLV 800 includes a type field 802, a length field 804, a prefix length field 806, a flags field 808, a source prefix field 810, and a next hop field 812. The type field 802 includes a value indicating that the sub-TLV 800 is being used to communicate information associated with the backup path of the sending network node. The length field 804 includes a value that specifies a length of the sub-TLV 800.

The prefix length field 806 includes a value that specifies a value of a prefix, such as the source prefix in the source prefix field 810. The flags field 808 includes a value that indicates whether the receiving network node (e.g., Router E) should switch from validating packets received from the source (e.g., Router A) using the entry in the incoming port column of the SAV table 600 to validating packets received from the source using the entry in the backup port column of the SAV table 600. For example, the first bit (e.g., bit-0) of the flags field 808 may be set to a first binary value (e.g., 0) to signify that the entry in the incoming port column should be used when validating packets. The first bit of the flags field 808 may be set to a second binary value (e.g., 1) to signify that that the entry in the backup port column should be used when validating packets.

The source prefix field 810 includes a value to indicate the source prefix, e.g., the source prefix associated with Router A in FIG. 6. The next hop field 812 includes a value that identifies a next hop of the network node that dispatched the sub-TLV 800. For example, when Router A transmits the sub-TLV 800, the next hop field includes a value to signify that Router B is the next hop on the backup path to Router E.

As noted above, FIGS. 7-8 are used for OSPFv2. A similar process is used for OSPFv3. For OSPFv3, a Router-Link TLV may be used in place of the OSPFv2 Extended Prefix TLV 700. The Router-Link TLV (not shown) may be used to carry the sub-TLV 800. Thus, the encoding for OSPFv3 is similar to the encoding for OSPFv2.

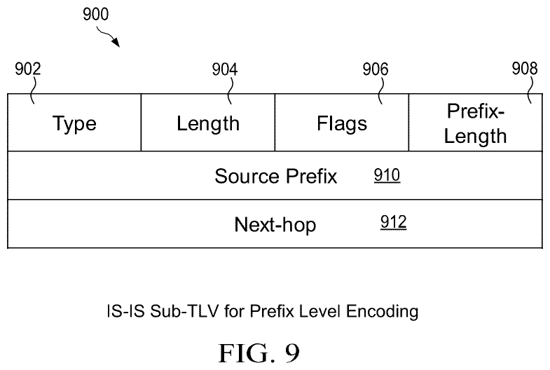

FIG. 9 is an IS-IS sub-TLV 900 for prefix level encoding according to an embodiment of the disclosure. The IS-IS sub-TLV 900 is configured to be included in an Extended IPv4 reachability TLV as described in IETF RFC 5305 entitled “IS-IS Extensions for Traffic Engineering” by T. Li, et al., published October 2008, a Multi-topology IPv4 Reachability TLV as described in IETF RFC 5120 entitled “M-ISIS: Multi Topology (MT) in Intermediate System to Intermediate Systems (IS-ISs)” by T. Przygienda, et al., published February 2008, an IPV6 IP Reachability TLV as described in IETF RFC 5308 entitled “Routing IPV6 with IS-IS” by C. Hopps, published October 2008, or a Multi-topology IPv6 Reachability TLV as described in IETF RFC 5120. In an embodiment, the IS-IS sub-TLV 900 is used by a network node (e.g., Router A) to advertise a backup path to be used following the detection of a failure in the IGP domain, and to advertise a switchover to the backup path after detection of the failure.

As shown, the IS-IS sub-TLV 900 includes a type field 902, a length field 904, a flags field 906, a prefix length field 908, a source prefix field 910, and a next hop field 912. The type field 902 includes a value indicating that the sub-TLV 900 is being used to communicate information associated with the backup path of the sending network node. The length field 904 includes a value that specifies a length of the sub-TLV 900.

The flags field 906 includes a value that indicates whether the receiving network node (e.g., Router E) should switch from validating packets received from the source (e.g., Router A) using the entry in the incoming port column of the SAV table 600 to validating packets received from the source using the entry in the backup port column of the SAV table 600. For example, the first bit (e.g., bit-0) of the flags field 906 may be set to a first binary value (e.g., 0) to signify that the entry in the incoming port column should be used when validating packets. The first bit of the flags field 906 may be set to a second binary value (e.g., 1) to signify that that the entry in the backup port column should be used when validating packets.

The prefix length field 908 includes a value that specifies a value of a prefix, such as the source prefix in the source prefix field 910. The source prefix field 910 includes a value to indicate the source prefix, e.g., the source prefix 10.10.10.0/24 in FIG. 6. The next hop field 912 includes a value that identifies a next hop of the network node that dispatched the sub-TLV 900. For example, when Router A transmits the sub-TLV 900, the next hop field includes a value to signify that Router B is the next hop on the backup path to Router E.

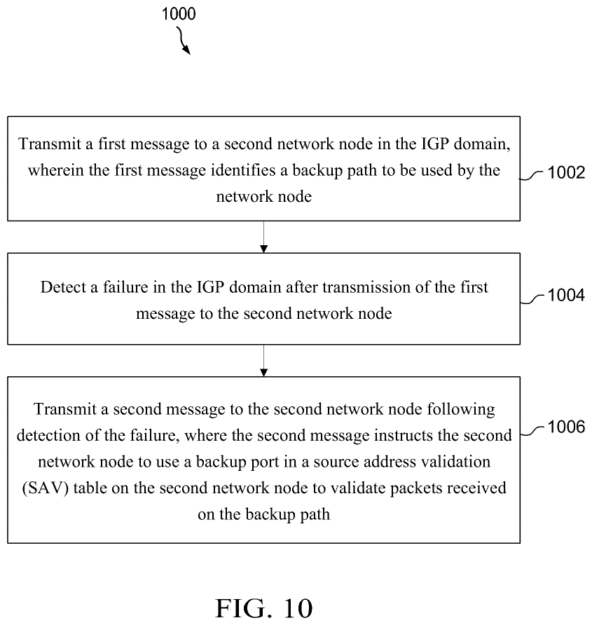

FIG. 10 is a method implemented by a network node in the IGP domain according to an embodiment of the disclosure. The method 1000 may be performed by a network node, such as Router A in FIGS. 4-5, to identify a backup path and to trigger a switchover to that backup path following detection of a failure in the IGP domain.

In block 1002, the network node transmits a first message to a second network node (e.g., Router E) in the IGP domain. In an embodiment, the first message identifies a backup path to be used by the network node upon detection of a failure in the IGP domain.

In block 1004, the network node detects the failure after transmission of the first message to the second network node. In block 1006, the network node transmits a second message to the second network node following detection of the failure. In an embodiment, the second message notifies the second network node to use a backup port in a source address validation (SAV) table on the second network node to validate packets received on the backup path.

In an embodiment, the SAV table is built based on only IGP and not any additional protocol. In an embodiment, the first message includes a source prefix field and a next hop field, the source prefix field includes a value that identifies the network node, and the next hop field includes a value that identifies a next hop of the network node on the backup path.

In an embodiment, the first message includes a type field, and a value in the type field indicates that the first message includes the backup path. In an embodiment, the source prefix field, the next hop field, and the type field are included in a sub-type length value (TLV).

In an embodiment, the sub-TLV is included in an Open Shortest Path First version 2 (OSPFv2) TLV or an Open Shortest Path First version 3 (OSPFv3) TLV. In an embodiment, the address prefix field includes a value identifying the second network node or a destination node.

In an embodiment, the second message includes a flags field, and the flags field includes a value that instructs the second network node to switch to the backup port. In an embodiment, the second message includes a source prefix field and a next hop field, the source prefix field includes a value that identifies the network node, and the next hop field includes a value that identifies a next hop of the network node on the backup path.

In an embodiment, one or both of the first message and the second message comprises an IGP update message, and the IGP update message comprises a link state update (LSU) corresponding to the OSPF protocol or a protocol data unit (PDU), known as a link state PDU (LSP), corresponding to the IS-IS protocol.

In an embodiment, the method 1000 further comprises transmitting packets on the backup path after the failure has been detected.

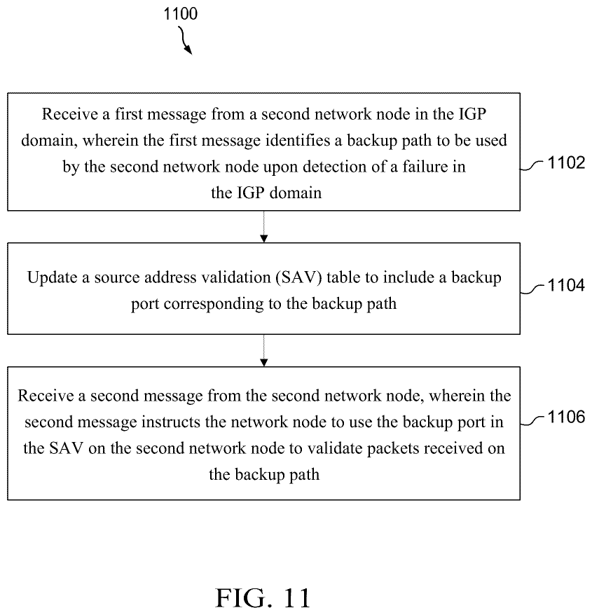

FIG. 11 is a method 1100 implemented by a network node in the IGP domain according to an embodiment of the disclosure. The method 1100 may be performed by a network node, such as Router E in FIGS. 4-5, to receive information regarding a backup path used by a transmitting network node, to update a SAV table to accommodate the backup bath, and to switch to using the backup path in the SAV table when instructed by the transmitting network node.

In block 1102, the network node receives a first message from a second network node (e.g., Router A) in the IGP domain. In an embodiment, the first message identifies a backup path to be used by the second network node upon detection of a failure in the IGP domain.

In block 1104, the network node updates a source address validation (SAV) table to include a backup port corresponding to the backup path. In block 1106, the network node receives a second message from the second network node. In an embodiment, the second message notifies the network node to use the backup port in the SAV table on the second network node to validate packets received on the backup path.

In an embodiment, the method 1100 further comprises performing a shortest path first (SPF) calculation using a value of zero for a metric between the second network node and a next hop of the second network node on the backup path to update the SAV table. In an embodiment, the method 1100 further comprises performing an initial SPF calculation to generate the SAV table, wherein the initial SPF calculation is performed prior to the SPF calculation. In an embodiment, the SAV table includes a backup port column identifying the backup port.

In an embodiment, the first message includes a source prefix field and a next hop field, the source prefix field includes a value that identifies the second network node, and the next hop field includes a value that identifies a next hop of the second network node on the backup path. In an embodiment, the first message includes a type field, and wherein a value in the type field indicates that the first message includes the backup path. In an embodiment, the source prefix field, the next hop field, and the type field are included in a sub-type length value (TLV).

In an embodiment, the sub-TLV is included in an Open Shortest Path First version 2 (OSPFv2) TLV, an Open Shortest Path First version 3 (OSPFv3) TLV, an Extended Internet

Protocol version 4 (IPv4) Reachability TLV, a Multi-Topology IPv4 Reachability TLV, an Internet Protocol version 6 (IPv6) Reachability TLV, or a Multi-Topology IPv6 Reachability TLV. In an embodiment, the OSPFv2 TLV or the OSPFv3 TLV include an address prefix field, and the address prefix field includes a value identifying the network node or a destination node.

In an embodiment, the second message includes a flags field, and the flags field includes a value that instructs the network node to switch to the backup port. In an embodiment, the second message includes a source prefix field and a next hop field, the source prefix field includes a value that identifies the second network node, and the next hop field includes a value that identifies a next hop of the second network node on the backup path.

In an embodiment, the method 1100 further comprises receiving a packet; verifying that the packet was received on the backup port corresponding to the second network node using the SAV table; and transmitting the packet from an outgoing port corresponding to a destination address using a forwarding information base (FIB) table.

In an embodiment, the method 1100 further comprises receiving a packet; determining that the packet was not received on the backup port corresponding to the second network node using the SAV table; and dropping the packet or transmitting the packet somewhere (e.g., another network node or a controller) for further inspection.

The disclosed embodiments offer advantages over existing technology. For example, the disclosed embodiments provide extensions to existing protocols to permit easy deployment, and make use of the existing information in routing protocols. The disclosed embodiments also resolve issues with existing RFP solutions, allow for easy deployment in IP networks, and function without having to upgrade network hardware. New encodings and algorithms may be used to achieve intra-domain source validation as disclosed herein.

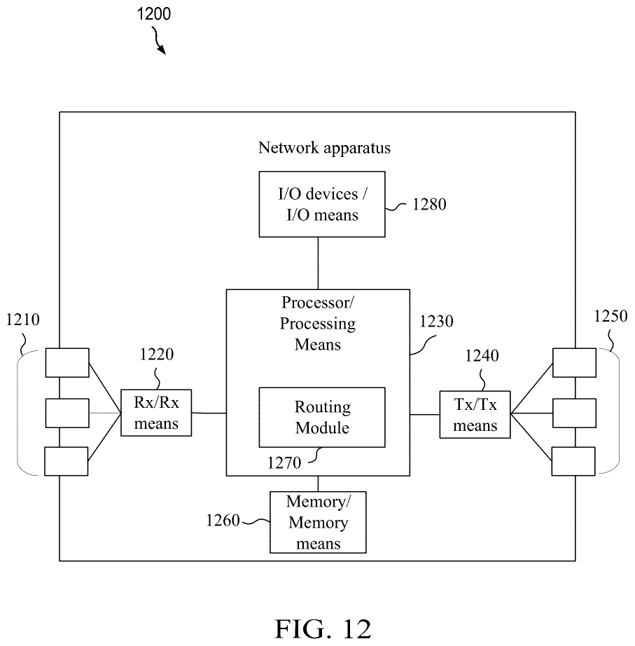

FIG. 12 is a schematic diagram of a network apparatus 1200 (e.g., a network node, a network router, a router, etc.). The network apparatus 1200 is suitable for implementing the disclosed embodiments as described herein. The network apparatus 1200 comprises ingress ports/ingress means 1210 (a.k.a., upstream ports) and receiver units (Rx)/receiving means 1220 for receiving data; a processor, logic unit, or central processing unit (CPU)/processing means 1230 to process the data; transmitter units (Tx)/transmitting means 1240 and egress ports/egress means 1250 (a.k.a., downstream ports) for transmitting the data; and a memory/memory means 1260 for storing the data. The network apparatus 1200 may also comprise optical-to-electrical (OE) components and electrical-to-optical (EO) components coupled to the ingress ports/ingress means 1210, the receiver units/receiving means 1220, the transmitter units/transmitting means 1240, and the egress ports/egress means 1250 for egress or ingress of optical or electrical signals.

The processor/processing means 1230 is implemented by hardware and software. The processor/processing means 1230 may be implemented as one or more CPU chips, cores (e.g., as a multi-core processor), field-programmable gate arrays (FPGAs), application specific integrated circuits (ASICs), and digital signal processors (DSPs). The processor/processing means 1230 is in communication with the ingress ports/ingress means 1210, receiver units/receiving means 1220, transmitter units/transmitting means 1240, egress ports/egress means 1250, and memory/memory means 1260. The processor/processing means 1230 comprises a routing module 1270. The routing module 1270 is able to implement the methods disclosed herein. The inclusion of the routing module 1270 therefore provides a substantial improvement to the functionality of the network apparatus 1200 and effects a transformation of the network apparatus 1200 to a different state. Alternatively, the routing module 1270 is implemented as instructions stored in the memory/memory means 1260 and executed by the processor/processing means 1230.

The network apparatus 1200 may also include input and/or output (I/O) devices or I/O means 1280 for communicating data to and from a user. The I/O devices or I/O means 1280 may include output devices such as a display for displaying video data, speakers for outputting audio data, etc. The I/O devices or I/O means 1280 may also include input devices, such as a keyboard, mouse, trackball, etc., and/or corresponding interfaces for interacting with such output devices.

The memory/memory means 1260 comprises one or more disks, tape drives, and solid-state drives and may be used as an over-flow data storage device, to store programs when such programs are selected for execution, and to store instructions and data that are read during program execution. The memory/memory means 1260 may be volatile and/or non-volatile and may be read-only memory (ROM), random access memory (RAM), ternary content-addressable memory (TCAM), and/or static random-access memory (SRAM).

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

1. A method implemented by a network node in an interior gateway protocol (IGP) domain, comprising:
transmitting a first message to a second network node in the IGP domain, wherein the first message identifies a backup path to be used by the network node upon detection of a failure in the IGP domain;
detecting the failure after transmission of the first message to the second network node; and
transmitting a second message to the second network node following detection of the failure, wherein the second message notifies the second network node to use a backup port in a source address validation (SAV) table on the second network node to validate packets received on the backup path.

2. The method of claim 1, wherein the SAV table is built based on only IGP and not any additional protocol.

3. The method of claim 1, wherein the first message includes a source prefix field and a next hop field, wherein the source prefix field includes a value that identifies the network node, and wherein the next hop field includes a value that identifies a next hop of the network node on the backup path.

4. The method of claim 1, wherein the first message includes a type field, and wherein a value in the type field indicates that the first message includes the backup path.

5. The method of claim 3, wherein the source prefix field, the next hop field, and the type field are included in a sub-type length value (TLV).

6. The method of claim 5, wherein the sub-TLV is included in an Open Shortest Path First version 2 (OSPFv2) TLV or an Open Shortest Path First version 3 (OSPFv3) TLV.

7. The method of claim 6, wherein the OSPFv2 TLV or the OSPFv3 TLV include an address prefix field, and wherein the address prefix field includes a value identifying the second network node or a destination node.

8. The method of claim 1, wherein the second message includes a flags field, wherein the flags field includes a value that instructs the second network node to switch to the backup port.

9. The method of claim 8, wherein the second message includes a source prefix field and a next hop field, wherein the source prefix field includes a value that identifies the network node, and wherein the next hop field includes a value that identifies a next hop of the network node on the backup path.

10. The method of claim 1, wherein one or both of the first message and the second message comprises an IGP update message, and wherein the IGP update message comprises a link state update (LSU) corresponding to an Open Shortest Path First (OSPF) protocol or a protocol data unit (PDU), known as a link state PDU (LSP), corresponding to an intermediate system-intermediate system (IS-IS) protocol.

11. The method of claim 1, further comprising transmitting packets on the backup path after the failure has been detected.

12. A method implemented by a network node in an interior gateway protocol (IGP) domain, comprising:
receiving a first message from a second network node in the IGP domain, wherein the first message identifies a backup path to be used by the second network node upon detection of a failure in the IGP domain;
updating a source address validation (SAV) table to include a backup port corresponding to the backup path; and
receiving a second message from the second network node, wherein the second message notifies the network node to use the backup port in the SAV table on the second network node to validate packets received on the backup path.

13. The method of claim 12, further comprising performing a shortest path first (SPF) calculation using a value of zero for a metric between the second network node and a next hop of the second network node on the backup path to update the SAV table.

14. The method of claim 12, further comprising performing an initial SPF calculation to generate the SAV table, wherein the initial SPF calculation is performed prior to the SPF calculation.

15. The method of claim 12, wherein the SAV table includes a backup port column identifying the backup port.

16. The method of claim 12, wherein the first message includes a source prefix field and a next hop field, wherein the source prefix field includes a value that identifies the second network node, and wherein the next hop field includes a value that identifies a next hop of the second network node on the backup path.

17. The method of claim 16, wherein the first message includes a type field, and wherein a value in the type field indicates that the first message includes the backup path.

18. The method of claim 17, wherein the source prefix field, the next hop field, and the type field are included in a sub-type length value (TLV).

19. The method of claim 18, wherein the sub-TLV is included in an Open Shortest Path First version 2 (OSPFv2) TLV, an Open Shortest Path First version 3 (OSPFv3) TLV, an Extended Internet Protocol version 4 (IPv4) Reachability TLV, a Multi-Topology IPv4 Reachability TLV, an Internet Protocol version 6 (IPv6) Reachability TLV, or a Multi-Topology IPv6 Reachability TLV, and wherein the OSPFv2 TLV or the OSPFv3 TLV include an address prefix field, and wherein the address prefix field includes a value identifying the network node or a destination node.

20. A network node in an interior gateway protocol (IGP) domain, comprising:
a memory configured to store instructions; and
one or more processors coupled to the memory and configured to execute the instructions to cause the network node to:
receive a first message from a second network node in the IGP domain, wherein the first message identifies a backup path to be used by the second network node upon detection of a failure in the IGP domain,
update a source address validation (SAV) table to include a backup port corresponding to the backup path, and
receive a second message from the second network node, wherein the second message notifies the network node to use the backup port in the SAV table on the second network node to validate packets received on the backup path.
